(19) United States
(12) Patent Application Publication
(10) Pub. No.: US 2004/0001255 A1
(43) Pub. Date: Jan. 1, 2004

(54) Polarization compensators and optical devices and systems incorporating polarization compensators

(75) Inventor: Vincent J. Fratello, Basking Ridge, NJ (US)

Correspondence Address: William Squire, Esq., c/o Carella, Byrne, Bain, Gilfillan, Cecchi,, Stewart & Olstein, 6 Becker Farm Road, Roseland, NJ, 07068, US

(73) Assignee: Integrated Photonics, Inc.

(21) Appl. No.: 10/187,277

(22) Filed: Jun. 28, 2002

(51) Int. Cl. G02B 5/30; G02B 27/28; H01S 3/00

(52) U.S. Cl. 359/484; 359/494; 359/497; 372/703

(57) ABSTRACT

Polarization compensators and devices and systems incorporating them including polarization rotator means that employ novel polarization compensation means. The novel polarization compensator means employs the use of a variable retarder means with retardation dependent on environmental, system or operating requirements coupled with a second retarder means of substantially 90 degrees of retardation at the center specification conditions of operation. The polarization compensator may be part of either a reciprocal or a non-reciprocal device also having Faraday rotator means with specific dependence on temperature and wavelength. To improve performance significantly, temperature and/or wavelength dependence of the variable retarder of the invention is adjusted to be between about 1 and 3 times and preferably between about 1.5 and 2.5 times) the temperature and/or wavelength dependence of the Faraday rotator. The polarization rotator will therefore compensate for the variability of the Faraday rotator such that the combined apparatus shall have a reduced dependence on wavelength and/or temperature of net polarization in the reverse direction. Performance of the non-reciprocal device will be thereby improved.

### FIELD OF THE INVENTION

This invention pertains to polarization compensators and devices and systems incorporating polarization compensators.

### BACKGROUND OF THE INVENTION

In many optical systems, it is desired to control precisely the linear polarization state of a beam of light. This is particularly true in optical communications systems that must operate at high bit rates. Components such as Faraday rotators are used in devices such as isolators and circulators in which the ability to operate is strongly dependent on the constancy of the state of polarization output by the component. Faraday rotator components such as Faraday rotator crystals are a dominant application in optical communications systems, however the present invention applies equally to devices other than Faraday rotator crystals that result in a variation of linear polarization. Many optical components have some dependence on the conditions of operation, specifically temperature and wavelength, that may vary from device to device, from application to application, or continuously under ambient conditions.

The prior art is exemplified in FIG. 1, which depicts a polarization-dependent magnetooptic isolator that includes a magnetooptic Faraday rotator of nominal Faraday rotation Θ₀=45 degrees (103), input (102) and output (105) polarizing means, and magnetic means (104) sufficient to saturate the magnetooptic means (103) in the single domain state required for device operation. Light propagating rearwardly (107) through the schema of FIG. 1 first passes through an exit polarizing means, for example as shown here a 45 degree polarizer (105), then through the Faraday rotator (103), which rotates the light an additional Θ=45±θ degrees, where the variation from ideality, ±θ, results from the temperature and/or wavelength dependence of the Faraday rotation. Light attempting to pass back through the 0 degree entry polarizer (102) will have a polarization of 90±θ degrees (108). The ability of an isolator to block reflected radiation is frequently expressed in terms of the “extinction ratio” of the device, which depends on the deviation, θ,

ER=−10 log (P₂/P₀)=−10 log (sin ²θ) (1)

(assuming perfect polarizers) where P₀ is the reverse incoming intensity of beam (107) parallel to the exit polarizer (105) and P₂ is the outgoing intensity of the reverse or rearwardly propagated beam (108) passing through the polarizer (102) toward the laser side. Imperfect polarizers and an imperfect Faraday rotator will yield a slightly broader peak in isolation with a finite maximum extinction ratio.

FIG. 2 depicts how the isolation or extinction ratio (reverse or rearward propagation) of a typical prior art device varies with varying Faraday rotation from any cause. The extinction ratio requirements of the device will govern how much deviation, ±θ, of the Faraday rotation is permitted. In many devices, there is sufficient variation of the state of polarization as to yield device performance that does not meet the required specification. In telecommunications applications, the typical sources of variation in component properties are temperature variation (thermal) and wavelength variation (chromatic dispersion). Device designers desire to make components that are either athermal, achromatic or both. A typical temperature range of operation is −40 to +85° C. The wavelength range depends on the application, but many communications applications require operation of a device over a range of ±20-30 nm from a center or target specification wavelength.

An optoelectronic device may be constructed to include a thermo-electric cooler, which controls the temperature of the device. If the Faraday rotator or other temperature-dependent material can be placed on the thermo-electric cooler, the effects of variation in the package case temperature may be reduced or eliminated. However many applications call for non-cooled devices. In all cases, a thermoelectric cooler cannot address the effects of chromatic dispersion.

In the prior art, temperature compensation has been addressed most thoroughly. Bismuth-doped, rare-earth iron garnet thick films are commonly used in optical communications systems because they have a high specific Faraday rotation Θ/t (t is thickness) and are highly transparent at the near infrared wavelengths of interest. See, for instance, a review by Fratello and Wolfe (in Magnetic Film Devices, edited by M. H. Francombe and J. D. Adam, Volume 4 of Handbook of Thin Film Devices: Frontiers of Research, Technology and Applications (Academic Press, 2000)). Such Faraday rotator materials can be made so that devices using them do or do not require a bias magnet to maintain them in the single domain configuration required for isolator operation. Materials designed for magnetless applications exhibit an even greater temperature dependence of Faraday rotation and therefore exhibit a still greater need for compensation.

The first idea to compensate the temperature dependence of the iron lattice component of Faraday rotation was to use a rare earth that provided a strongly temperature dependent Faraday rotation of opposite sign. See, for example, Umezawa et al., J. Appl. Phys. 63, 3113 (1988) or Honda et al., J. Magn. Soc. Jpn. 11. Supplement S1, 361 (1987). This counters the Faraday rotation of the iron lattice, but most strongly at lower temperature so the overall temperature dependence of the material is reduced. See V. J. Fratello and R. Wolfe, “Epitaxial Garnet Films for Non-Reciprocal Magnetooptic Devices,” book chapter in Magnetic Film Devices, edited by M. H. Francombe and J. D. Adam, Volume 4 of Handbook of Thin Film Devices: Frontiers of Research, Technology and Applications (Academic Press, 2000) for details. This approach is not effective in compensating chromatic dispersion.

The principle of using a subtractive factor can be taken another step by using two thick film materials. See, for example, Matsuda et al., Appl. Optics 27, 1329 (1988), Minemoto et al., J. Magn. Soc. Jpn. 11, Supplement S1, 357 (1987) and Machida et al., Optoelectronics 3, 99 (1988). The base composition is a standard bismuth-doped rare-earth iron garnet with little or no substitution of gallium or aluminum on the iron lattice, which has a negative Faraday rotation. The subtractive composition is a different bismuth-doped rare-earth iron garnet with a high degree of substitution (generally gallium, aluminum or both) on the iron lattice. This layer has a small positive Faraday rotation (because the material is doped past the compensation point) with a strong temperature dependence (because the doping has reduced the Curie temperature, T_{c}, to the top of the operating range).

FIG. 3 depicts that it is possible to get a nearly zero temperature variation in the Faraday rotation in the composite material in the temperature region of interest. The drawback to this approach is that substantially more material must be used. The base composition must be grown with a rotation much greater than the desired 45 degrees so that the subtractive layer will bring it down to 45 degrees, resulting in a total thickness two to three times that of a single layer material. Growth of such monolithic thick films is difficult because of film cracking and using multiple chips is more expensive. The additional thickness will also substantially increase the insertion loss (−10×log(P₁/P₀) where P₀ and P₁ are the incoming and outgoing intensities of the forward-propagating signal respectively), which results from the specific absorption of the material. This approach is not effective in compensating chromatic dispersion.

Brandle et al. (U.S. Pat. No. 4,981,341) proposed the use of a composite Faraday rotator consisting of a base composition and a layer or layers containing a compensation point within the temperature range of operation. This layer or layers will have a step function in Faraday rotation versus temperature when magnetically saturated by suitable magnetizing means. This results in lower excursions (variations from 45 degrees) of net Faraday rotation as is depicted in FIG. 4. This approach is not effective in compensating chromatic dispersion.

Of course, two Faraday rotator chips can be used to make a double or cascade isolator. This effectively doubles the extinction ratio of an isolator and can compensate for both temperature and wavelength (chromatic dispersion) variation. Takeda et al. (Conference on Lasers and Electrooptics Digests, Anaheim, Calif., Apr. 25-29, 1988, Paper WY-02) optimized such a cascade isolator. Two isolators (made with yttrium iron garnet) were placed back to back so the effects were cumulative. The net extinction ratio was 60 dB. The polarizers were slightly mis-oriented in each isolator so that one set differed by slightly more than 45 degrees and one by slightly less. Thus when the temperature or wavelength varies in either direction, one isolator will be less effective, but the other will become more effective and the cumulative effect remains the same. While this can be a useful scheme, it is twice as expensive and has twice the insertion loss of a single device.

A similar principle was used by Bohnert et al. (J. Lightwave Tech. 20, 267 (2002). They discuss a Sagnac fiber-optic current sensor comprised of 1) a paramagnetic fiber used as a magnetooptic rotator for circularly polarized light and 2) one (reflective configuration) or two (two branch configuration) quarter wave fiber retarders. The quarter wave retarder(s) convert incoming linearly polarized light to circularly polarized light and outgoing circularly polarized light back to linearly polarized light. Circularly polarized light of opposite circular polarizations propagates in opposite directions through the magnetooptic rotator fiber coil. The magnetic field induced by current passing through a magnetic coil surrounding the fiber coil causes a phase shift between these two polarizations that is then detected by interferometric methods outside the sensor coil. The sensitivity of the device is dependent on both the Verdet constant (rotation per unit length per unit of applied magnetic field) of the magnetooptic rotator fiber and the accuracy of the quarter wave retarders. Both these components have a temperature dependence. The authors detuned the retardation of the quarter wave retarder(s) so that the two temperature dependences result in opposite effects on the sensitivity. Accordingly the sensitivity of the sensor remains constant with temperature, though as a result the overall sensitivity is impaired. Although this device utilizes much of the same terminology as the present invention, it is substantially different because the magnetooptic fiber rotator only acts on the phase of the beams.

Fukushima (U.S. Pat. No. 5,844,710) and Kawai et al. (U.S. Pat. No. 6,288,827) have suggested using a Faraday rotator such that the device will have a Faraday rotation of 45 degrees at the extreme low limit of the Faraday rotation range. Then a magnetic field is applied at all other conditions so as to cant the magnetic domains and reduce the net Faraday rotation by the cosine of the angle of the domains with the film normal. An algorithm or feedback loop can be used to maintain the Faraday rotation at or near 45 degrees under all specification conditions. This requires a bulky electromagnet with a high power budget and a complex control circuit. This device has a high thermal mass and generates significant heat in its own right.

Chang et al. (U.S. Pat. No. 4,974,944 and Optics Letters 15, 449 (1990)) have outlined a polarization independent isolator comprised of alternating birefringent and Faraday rotator elements in two to three stages. The birefringent walk-off plates break up the polarization exiting the Faraday rotators so that the desired 45 degree component (ordinary ray) is propagated directly and the undesired perpendicular component (extraordinary ray) resulting from the Faraday rotation varying from 45 degrees is substantially redirected out of the return path. While this method is effective in reducing temperature and wavelength dependence, it also results in a high forward insertion loss of approximately 2 dB, which is not acceptable to most device designers.

Wavelength compensation was accomplished by Schulz (Appl. Optics 28, 4458 (1989) and U.S. Pat. No. 5,052,786) using an optically active rotator material, OAR (FIG. 5). The thickness of the optically active rotator was tuned to have the same wavelength dependence per nm as the Faraday rotator, but it was oriented to have the opposite sign of rotation. Thus the effects in the two materials cancelled out. An exemplary device was made at a wavelength of 800 nm, which is not a customary communications wavelength. Devices of the type disclosed in U.S. Pat. No. 5,052,786 would not be practical at telecommunications wavelengths of 1310 nm and 1550 nm because the optical rotation per unit length of the optically active material is low at these wavelengths and excessive path lengths would be required. This device is not effective for thermal compensation.

A method of varying linear polarization can be made by consecutively passing light through a retarder plate of variable retardation with its fast axis oriented at 45 degrees to the incoming polarization, followed by a quarter wave retarder of constant or nearly constant retardation with its fast axis oriented either at 0 degrees or 90 degrees to the incoming polarization. This is sometimes called a Sénarmont rotator (Ye, U.S. Pat. No. 5,473,465) and is effective in the forward direction, but in this configuration can only be used in the reverse direction if the variable retarder has a retardance that is an odd multiple of 90 degrees or nearly so. (A variable rotator sandwiched between two constant quarter wave plates is effective in both directions, Ye, U.S. Pat. No. 5,473,465.) Sénarmont polarization rotators are completely effective only if the orientations of the polarizers are perfectly tuned to the polarization of the incoming light (H. G. Jerrard, J. Opt. Soc. Am. 38, 35 (1948). Devices using a liquid crystal as the variable retarder are discussed in Meadowlark Optics Application Notes, Basic Polarization Techniques, which can be found at http://www.meadowlark.com/appnotes/appnote1.htm. It is also contemplated that variable retardation may be accomplished by moving a pair of wedge retarders or by tilting or changing the angle of incidence of the incoming beam to a retarder plate. In all these cases, the variable retarder is actively controlled to achieve polarization control. To use such active control for polarization compensation would require a feedback circuit of some complexity and would exhibit a significant time lag. Additionally many telecommunications designers are resistant to the use of liquid crystals in devices, particularly if they are to be hermetically sealed. Mechanical moving parts are also undesirable in high reliability and/or high speed applications.

### SUMMARY OF THE INVENTION

A polarization compensator for use in devices or systems such as an optical device or an optical communication system containing a polarization rotator that includes two retarders. Each retarder defines a major surface, a thickness, an axis of birefringence and exhibits a specific retardation (retardation per unit thickness). The device typically includes means (e. g. a radiation source and an optical fiber for causing electromagnetic radiation (incident radiation) of wavelength λ (e. g. a conventional communications wavelength such as 1310 nm, 1550 nm or a pump wavelength such as 1480 nm) to engage the major surface with at least some (typically nearly all) of the incident radiation transmitted consecutively through the retarders each of the two retarders for reception by appropriate utilization means (e. g. polarizer, optical fiber and/or a detector).

In one particular embodiment, the first of the two retarders (retarder 1) has a variable retardation dependent on temperature, wavelength and/or other system parameters and the second of the two retarders (retarder 2) has a reduced dependence on temperature, wavelength and other system parameters.

The variable dependence of retarder 1 may be adjusted through choice of material or materials and thickness or thicknesses to compensate the polarization variation of other system components. A significant improvement in performance can be achieved if the absolute value of the variation of retardation over the range of operation is between 1 and 3 times the absolute value of the variation of system polarization. In one preferred embodiment, the absolute value of the variation of retardation over the range of operation is between 1.5 and 2.5 times the absolute value of the variation of system polarization.

In another embodiment, a significant improvement can be achieved if the absolute value of the temperature dependence of retardation shall be between 1 and 3 times (preferably between 1.5 and 2.5 times) that of the absolute value of the temperature dependence of system polarization.

In yet another embodiment, a significant improvement can be achieved if the absolute value of the wavelength dependence of retardation shall be between 1 and 3 times (preferably between 1.5 and 2.5 times) the absolute value of the wavelength dependence of system polarization.

Commonly the variation of system polarization with wavelength and temperature will arise from the variation of Faraday rotation with wavelength and temperature in a magnetooptic component such as a nominal 45 degree garnet Faraday rotator. In accordance with the present invention, embodiments may exhibit:

(1) an absolute value of the wavelength dependence of retarder 1 of between about 1 and 3 times the absolute value of the wavelength dependence of the Faraday rotator or;

(2) an absolute value of the temperature dependence of retarder 1 of between about 1 and 3 times the absolute value of the temperature dependence of the Faraday rotator; or

(3) both conditions (1) and (2) as set forth immediately above.

A preferred embodiment of the invention may exhibit:

(1) an absolute value of the wavelength dependence of retarder 1 of between about 1.5 and 2.5 times the absolute value of the wavelength dependence of the Faraday rotator; or

(2) an absolute value of the temperature dependence of retarder 1 of between about 1.5 and 2.5 times the absolute value of the temperature dependence of the Faraday rotator; or

both conditions (1) and (2) as set forth immediately above.

For a device embodying the present invention to be completely bi-directional, the retardation of retarder 1 should be some integer multiple of 90 degrees. Since retarder 1 is intended to exhibit variable retardation, complete bi-directionality will not exist throughout the wavelength and/or temperature range of operation. In a preferred embodiment of a device embodying the present invention, the retardation of retarder 1 is about (n×90) ± about 5 degrees (where n is an integer) at some point in the wavelength range comprising the specification wavelength ±30 nm and at some point in the temperature range −40 to +85° C.

The device described immediately above will exhibit higher performance if retarder 2 is invariant over the conditions of operation. In such an embodiment, retarder 2 has a range of retardation no greater than about ±6 degrees over the range of operation. In a preferred embodiment, retarder 2 has a range of retardation no greater than about ±2 degrees over the range of operation.

The angle between the fast axes of retarder 1 and retarder 2 may be about 45± about 5 degrees, with a preferred embodiment of about 45± about 2 degrees.

Commonly Faraday rotator materials are contained in non-reciprocal devices such as isolators and circulators. To be effective, the polarization rotator must be included between the two polarizing or polarization separation means of such a device or system. For maximum effectiveness, the retarders should be disposed such that retarder 2 precedes retarder 1 for forward propagation of light and retarder 1 precedes retarder 2 for reverse propagation of light.

### BRIEF DESCRIPTION OF THE DRAWINGS

FIG. 1 schematically depicts the design and operation of a prior art polarization-dependent isolator.

FIG. 2 is a plot of the isolation (extinction ratio) of the prior art device of FIG. 1 as a function of the change of Faraday rotation Θ from the ideal value of 45 degrees.

FIG. 3 is a comparative plot of Faraday Rotation against Temperature for a prior art composite Faraday rotator comprised of two Faraday rotators of opposite sign whose temperature dependences approximately cancel in the temperature range of device operation.

FIG. 4 is a comparative plot of Faraday Rotation against Temperature for a prior art composite Faraday rotator device having two Faraday rotators one a standard 45-47 degree Faraday rotator and the second a compensation wall Faraday rotator that minimizes the overall variation of Faraday rotation with temperature. (See Brandle et al., U.S. Pat. No. 4,981,341)

FIG. 5 is a comparative plot of Faraday Rotation against Wavelength of a prior art composite isolator containing a Faraday Rotator (FR) and an Optically Active Rotator (OAR) both of which rotate the polarization linearly, but in which the former is non-reciprocal and the latter is reciprocal. The device is tuned so the two dispersions approximately cancel in the wavelength range of device operation. (See Schulz, U.S. Pat. No. 5,052,786)

FIG. 6 is a schematic depiction of different designs for polarization-dependent magnetooptic isolators of the present invention that incorporate variable retarders of nominal 90 degrees retardation (6a), 180 degrees retardation (6b) and 270 degrees retardation (6c) at the center specification conditions.

FIGS. 7 a, b and c show the Mueller matrix formulations for the designs of FIGS. 6 a, b and c respectively.

FIG. 8 depicts the design for a polarization-independent magnetooptic isolator of the present invention utilizing two walkoff plates as polarization separation means and an internal design similar to that depicted in FIG. 6a.

### DETAILED DESCRIPTION

A polarization rotator having a variable and a fixed retarder can be constructed that is passively varied as for example by temperature, wavelength or system factors. In this case, the variable rotator consists of a material with temperature and/or wavelength dependence that matches that of the Faraday rotator or other temperature and/or wavelength dependent component. A polarization rotator of this character is a reciprocal component, while a Faraday rotator is non-reciprocal. Utilization of a reciprocal component to compensate a non-reciprocal component maintains the overall non-reciprocal operation of the device.

In a preferred embodiment, a temperature and/or wavelength compensated non-reciprocal optical device can be created by consecutively passing light through a sequence of elements comprising a temperature/wavelength-dependent Faraday rotator and a polarization compensating temperature/wavelength-dependent polarization rotator. The following examples illustrate embodiments of the present invention.

### EXAMPLE NUMBER 1

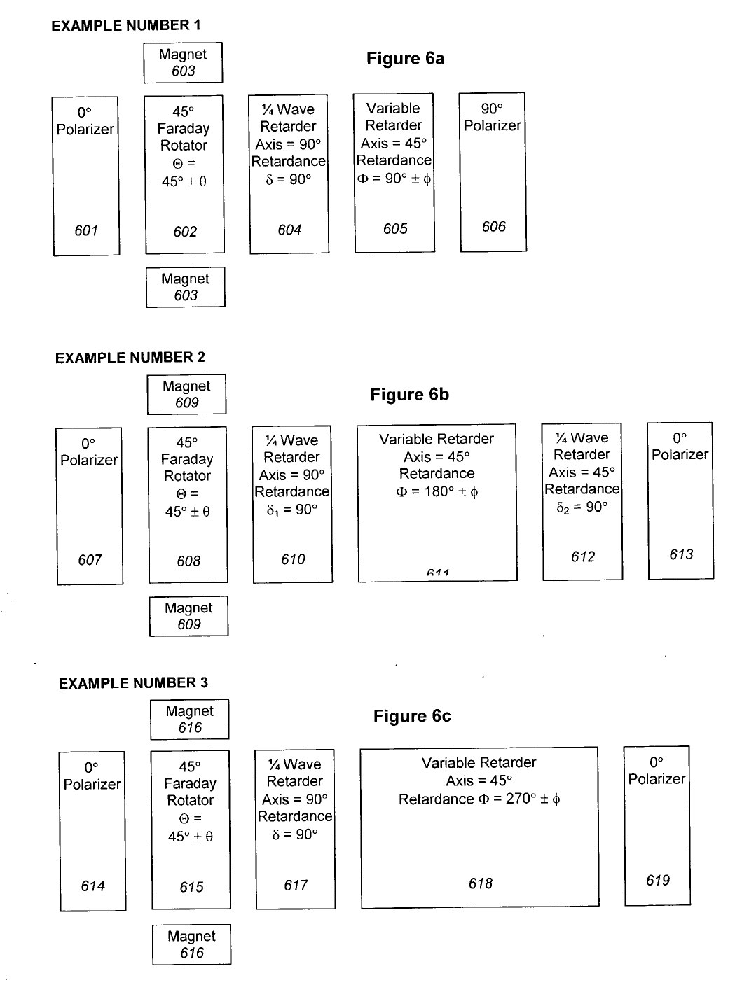

FIG. 6a depicts a polarization-dependent isolator design using a temperature and/or wavelength-dependent wave plate 605 with a nominal center value of 90 degrees of retardation (quarter wave plate). Specifically the device of this embodiment includes consecutively the following elements. Each element is further described by the Mueller matrix description of its operation on the incoming vector in the forward direction. For a complete explanation of Mueller matrices and their use, see, for example E. Collett, Polarized Light (Marcel Dekker, 1993). No absorption or depolarization is taken into account in this example, but in reality actual devices contain small amounts of these effects.

In the following discussion, the following typical specification range for a telecommunications device is assumed:

Temperature in the range of about −40° C. to +85° C. The variation of Faraday rotation over this temperature range is about θ=±2.5-6 degrees depending on the Faraday rotator material used.

Wavelength in the range of about 1280-1340 nm or 1520-1580 nm. The variations of Faraday rotation over these wavelength ranges are about θ=±2.4 degrees and θ=±1.6 degrees respectively. Element 601 represents polarizing means with a nominal polarization axis of 0 degrees. If the incident light is of 0 degree polarization with unit intensity, the Mueller matrix description of the operation of this device in a forward direction is:

$$[ \begin{matrix}0.5 & 0.5 & 0 & 0 \\ 0.5 & 0.5 & 0 & 0 \\ 0 & 0 & 0 & 0 \\ 0 & 0 & 0 & 0\end{matrix} ] \times [ \begin{matrix}1 \\ 1 \\ 0 \\ 0\end{matrix} ] = [ \begin{matrix}1 \\ 1 \\ 0 \\ 0\end{matrix} ]$$

Element 602 represents Faraday rotator means with a nominal Faraday rotation of about Θ₀=45 degrees at the center specification of temperature and wavelength. Such Faraday rotator materials have well characterized dependences on wavelength (dispersion) and temperature such that the Faraday rotation at any given condition is Θ=Θ₀+θ, where θ is a function of wavelength and temperature and may be positive or negative. Operating on the output of the polarizer element, 601, the Mueller matrix description of this device is:

$$[ \begin{matrix}1 & 0 & 0 & 0 \\ 0 & cos ( 2 Θ ) & - sin ( 2 Θ ) & 0 \\ 0 & sin ( 2 Θ ) & cos ( 2 Θ ) & 0 \\ 0 & 0 & 0 & 1\end{matrix} ] \times [ \begin{matrix}1 \\ 1 \\ 0 \\ 0\end{matrix} ] = [ \begin{matrix}1 & 0 & 0 & 0 \\ 0 & - sin ( 2 θ ) & - cos ( 2 θ ) & 0 \\ 0 & cos ( 2 θ ) & - sin ( 2 θ ) & 0 \\ 0 & 0 & 0 & 1\end{matrix} ] \times [ \begin{matrix}1 \\ 1 \\ 0 \\ 0\end{matrix} ] = [ \begin{matrix}1 \\ - sin ( 2 θ ) \\ cos ( 2 θ ) \\ 0\end{matrix} ]$$

Element 603, represents magnetization means to maintain the Faraday rotator in the magnetically-saturated, single-domain configuration required for device operation. More specifically, the magnetization means should be capable of applying a magnetic field greater than or equal to the saturating magnetic field of the Faraday rotator. For the case of coercive or magnetless Faraday rotator garnets (Brandle et al. U.S. Pat. Nos. 5,608,570 and 5,801,975), no such magnetization means is required.

Element 604, represents a retarder wave plate with a fast polarization axis of 90 degrees (relative to the input polarizer) and a nominal retardation δ=90 degrees at the temperature and wavelength conditions of operation. This is commonly called a quarter wave plate. In one preferred embodiment, this wave plate has a reduced dependence on temperature and/or wavelength in the range of operation. In a still more preferred embodiment, the retardation of this wave plate remains between about 89 and 91 degrees in the specification range (a typical specification range is given above). The Mueller matrix below assumes a retardation of precisely 90 degrees.

$$[ \begin{matrix}1 & 0 & 0 & 0 \\ 0 & 1 & 0 & 0 \\ 0 & 0 & 0 & - 1 \\ 0 & 0 & 1 & 0\end{matrix} ] \times [ \begin{matrix}1 \\ - sin ( 2 θ ) \\ cos ( 2 θ ) \\ 0\end{matrix} ] = [ \begin{matrix}1 \\ - sin ( 2 θ ) \\ 0 \\ cos ( 2 θ )\end{matrix} ]$$

Element 605 represents a temperature and/or wavelength-dependent retarder wave plate with a fast polarization axis of 45 degrees (relative to the input polarizer) and a nominal retardation of Φ₀=90 degrees at the center temperature and wavelength conditions of operation. This is commonly called a quarter wave plate. In one preferred embodiment, the variable retardation (Φ=Φ₀+φ) of this wave plate has a dependence on temperature (T) and/or wavelength (λ) approximately twice that of the temperature and/or wavelength dependence of the Faraday rotation (Θ) of element 602 in the range of operation. In a still more preferred embodiment 2×|dΘ/dT|=|dΦ/dT| and 2×|dΘ/dλ|=|dΦ/dλ|.

$$[ \begin{matrix}1 & 0 & 0 & 0 \\ 0 & - sin ( φ ) & 0 & - cos ( φ ) \\ 0 & 0 & 1 & 0 \\ 0 & cos ( φ ) & 0 & - sin ( φ )\end{matrix} ] \times [ \begin{matrix}1 \\ - sin ( 2 θ ) \\ 0 \\ cos ( 2 θ )\end{matrix} ] = [ \begin{matrix}1 \\ - cos ( φ ) cos ( 2 θ ) + sin ( φ ) sin ( 2 θ ) \\ 0 \\ - sin ( φ ) cos ( 2 θ ) - cos ( φ ) sin ( 2 θ )\end{matrix} ] = [ \begin{matrix}1 \\ - cos ( φ + 2 θ ) \\ 0 \\ - sin ( φ + 2 θ )\end{matrix} ]$$

Element 606 represents polarizing means with a nominal polarization axis of 90 degrees (relative to the input polarizer).

$$[ \begin{matrix}0.5 & - 0.5 & 0 & 0 \\ - 0.5 & 0.5 & 0 & 0 \\ 0 & 0 & 0 & 0 \\ 0 & 0 & 0 & 0\end{matrix} ] \times [ \begin{matrix}1 \\ - cos ( φ + 2 θ ) \\ 0 \\ - sin ( φ + 2 θ )\end{matrix} ] = [ \begin{matrix}0.5 \times ( 1 + cos ( φ + 2 θ ) ) \\ - 0.5 \times ( 1 + cos ( φ + 2 θ ) ) \\ 0 \\ 0\end{matrix} ]$$

This yields a theoretical overall insertion loss of −10×log(0.5×(1+cos (φ+2θ)) for perfect polarizers, Faraday rotator and retarders. Absorption, depolarization or other optical aberrations, will increase the insertion loss as is typical in these devices.

For reverse propagation, the Mueller matrix formulation is as follows assuming a unitary reverse input vector of 90 degrees polarization:

$$\begin{matrix}[ \begin{matrix}0.5 & - 0.5 & 0 & 0 \\ - 0.5 & 0.5 & 0 & 0 \\ 0 & 0 & 0 & 0 \\ 0 & 0 & 0 & 0\end{matrix} ] \times [ \begin{matrix}1 \\ - 1 \\ 0 \\ 0\end{matrix} ] = [ \begin{matrix}1 \\ - 1 \\ 0 \\ 0\end{matrix} ] . & 606 \\ [ \begin{matrix}1 & 0 & 0 & 0 \\ 0 & - sin ( φ ) & 0 & - cos ( φ ) \\ 0 & 0 & 1 & 0 \\ 0 & cos ( φ ) & 0 & - sin ( φ )\end{matrix} ] \times [ \begin{matrix}1 \\ - 1 \\ 0 \\ 0\end{matrix} ] = [ \begin{matrix}1 \\ sin ( φ ) \\ 0 \\ - cos ( φ )\end{matrix} ] . & 605 \\ [ \begin{matrix}1 & 0 & 0 & 0 \\ 0 & 1 & 0 & 0 \\ 0 & 0 & 0 & - 1 \\ 0 & 0 & 1 & 0\end{matrix} ] \times [ \begin{matrix}1 \\ sin ( φ ) \\ 0 \\ - cos ( φ )\end{matrix} ] = [ \begin{matrix}1 \\ sin ( φ ) \\ cos ( φ ) \\ 0\end{matrix} ] . & 604 \\ [ \begin{matrix}1 & 0 & 0 & 0 \\ 0 & - sin ( 2 θ ) & - cos ( 2 θ ) & 0 \\ 0 & cos ( 2 θ ) & - sin ( 2 θ ) & 0 \\ 0 & 0 & 0 & 1\end{matrix} ] \times [ \begin{matrix}1 \\ sin ( φ ) \\ cos ( φ ) \\ 0\end{matrix} ] = [ \begin{matrix}1 \\ - cos ( φ ) cos ( 2 θ ) - sin ( φ ) sin ( 2 θ ) \\ sin ( φ ) cos ( 2 θ ) - cos ( φ ) sin ( 2 θ ) \\ 0\end{matrix} ] = [ \begin{matrix}1 \\ - cos ( φ - 2 θ ) \\ sin ( φ - 2 θ ) \\ 0\end{matrix} ] . & 603 \\ [ \begin{matrix}0.5 & 0.5 & 0 & 0 \\ 0.5 & 0.5 & 0 & 0 \\ 0 & 0 & 0 & 0 \\ 0 & 0 & 0 & 0\end{matrix} ] \times [ \begin{matrix}1 \\ - cos ( φ - 2 θ ) \\ sin ( φ - 2 θ ) \\ 0\end{matrix} ] = [ \begin{matrix}0.5 \times ( 1 - cos ( φ - 2 θ ) ) \\ 0.5 \times ( 1 - cos ( φ - 2 θ ) ) \\ 0 \\ 0\end{matrix} ] . & 602\end{matrix}$$

This yields a theoretical overall extinction ratio of −10×log(0.5×(1−cos (φ−2θ)) for perfect polarizers, Faraday rotator and retarders. The extinction ratio is maximized (i. e. reverse propagation is minimized) in this device design for φ=2θ. Since the temperature and wavelength dependences of Faraday rotation and retardation are typically negative, the device was designed to be optimized for φ and θ of the same sign, but similar designs can be created when they are of opposite signs. Because of the variation in the Faraday rotation, propagation can only be optimized in one direction. As a consequence, forward propagation is not perfectly tuned and the device will have an additional insertion loss on top of the intrinsic insertion loss of the materials and device construction equal to −10×log(0.5×(1+cos (φ+2θ)). The Mueller matrix formulation shows that this results because a) the angle of polarization exiting the Faraday rotator in the forward direction is not perfectly oriented with respect to the axes of the two retarders and b) the variable wave plate is no longer a perfect multiple of 90 degrees. As was noted above, the polarization rotator will not put out linearly polarized light in its reverse operation (forward operation of the isolator device) under these conditions.

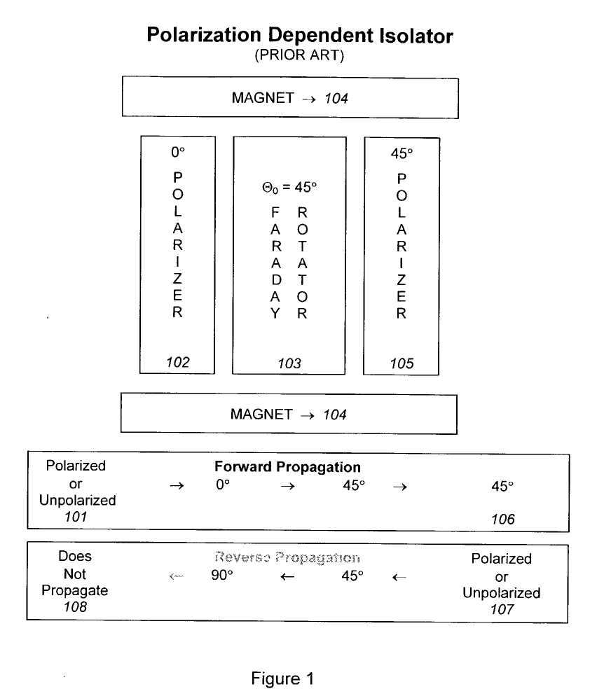

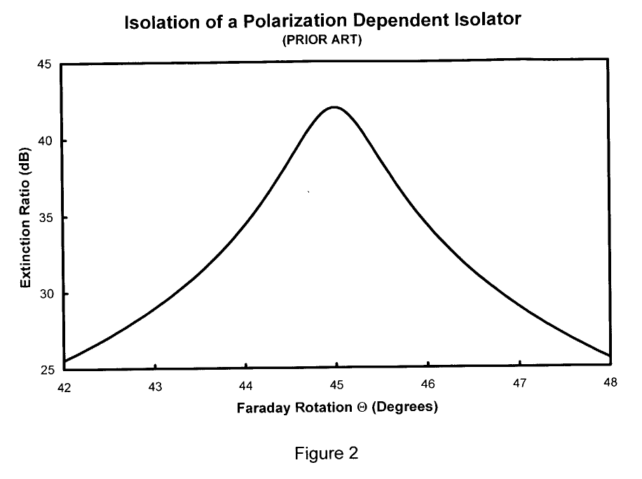

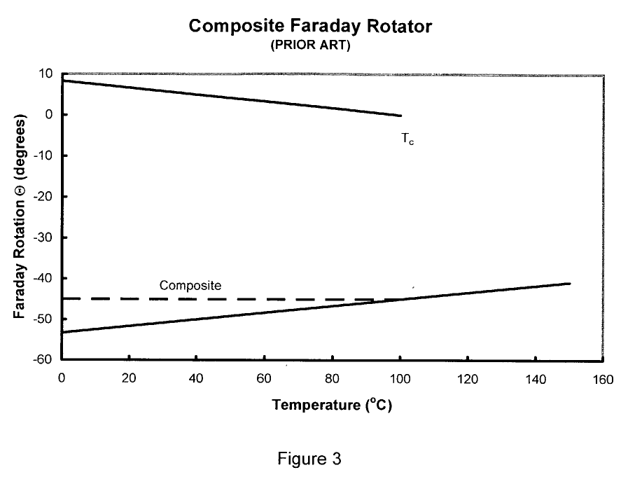

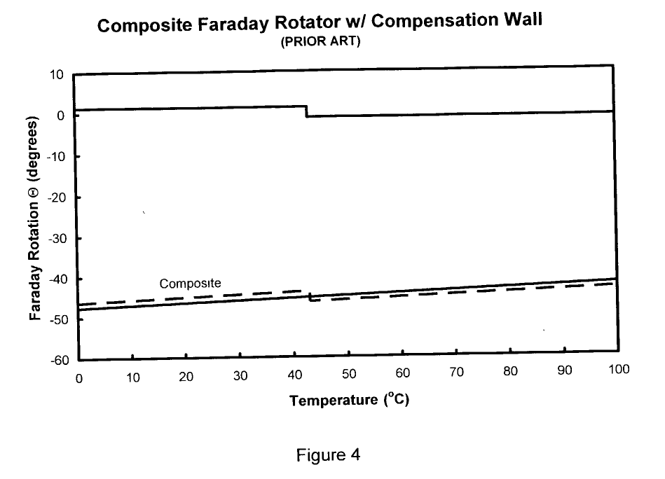

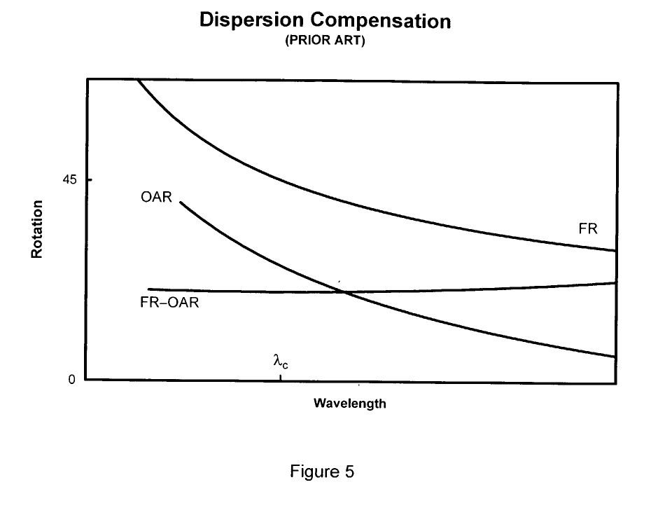

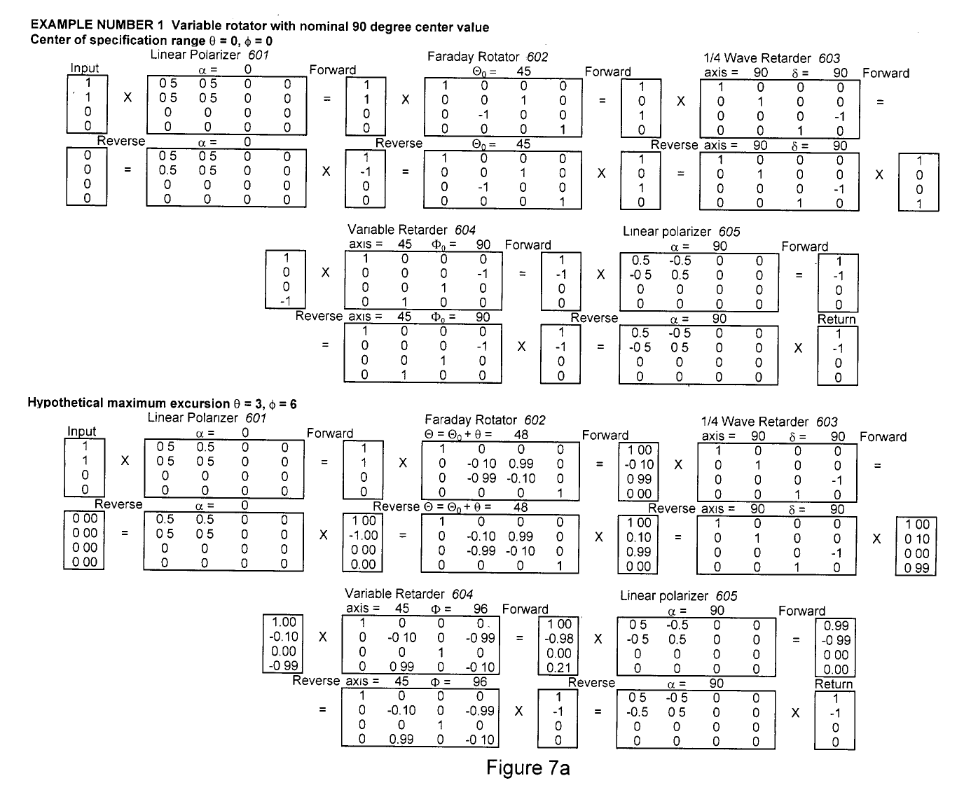

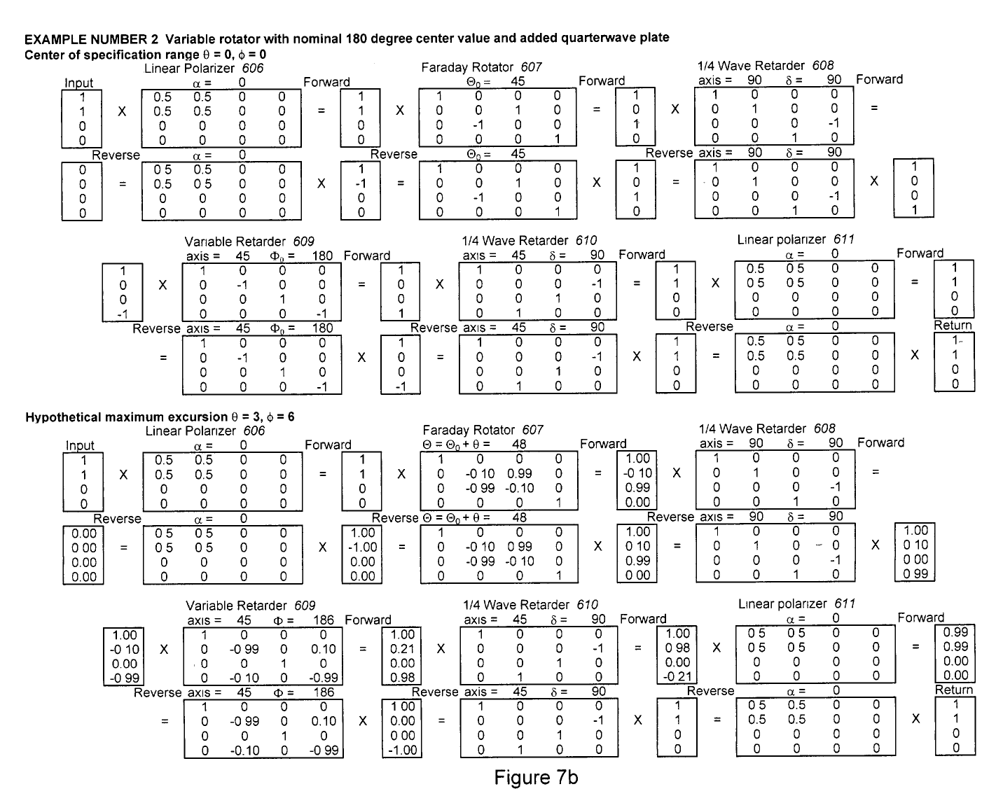

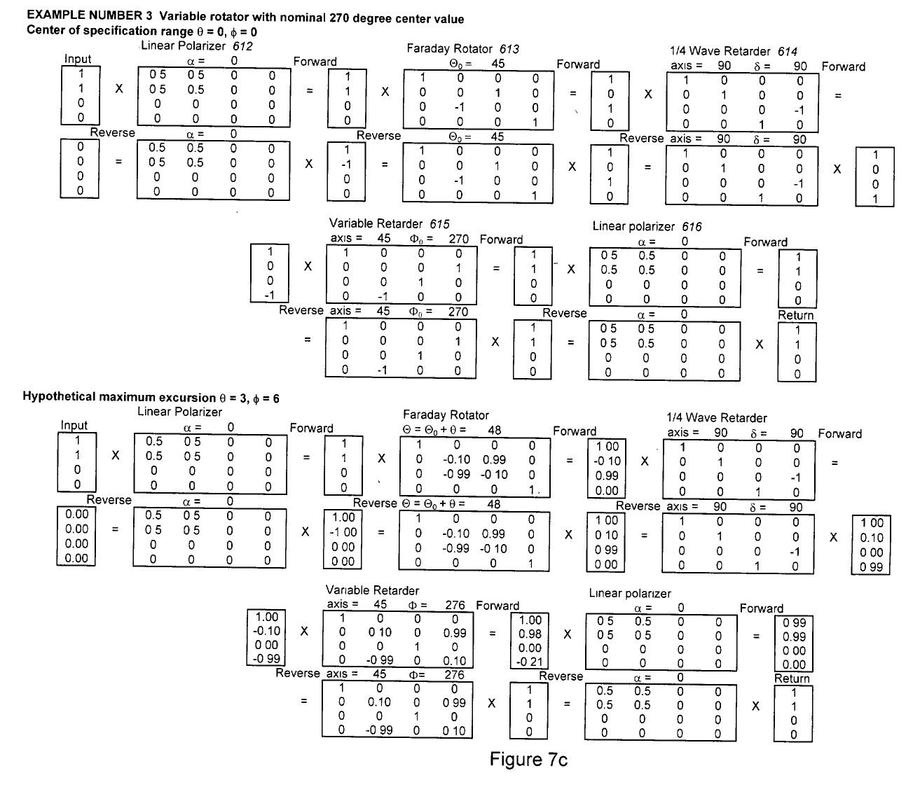

A numerical Mueller matrix description of this device is shown in FIG. 7a. The top two lines of matrices show forward and reverse propagation respectively for the center nominal values of the Faraday rotator 602, Θ₀=45 degrees, and the variable wave plate 605, Φ₀=90 degrees, which is nominally perfect propagation. The second two rows show forward and reverse propagation for a hypothetical maximum excursion (upper limit) of the variable wave plate 605 and Faraday rotator 602, φ=2θ=6 degrees, resulting from changes in temperature and/or wavelength. The results would be similar for the lower limit of variation, φ=2θ=−6 degrees. In this formulation, it is supposed that the first quarter wave plate has a constant retardation. For optimum device operation, the device design and temperature/wavelength dependence of the variable wave plate 605 have been optimized for minimum (zero) reverse propagation, i. e. φ=2θ. For the large excursion, φ=2θ=6 degrees, hypothesized here, the added insertion loss would be 0.05 dB compared to an added loss of 0.01 dB for the prior art device depicted in FIG. 1. For most specifications, this amount of variable insertion loss is acceptable in an isolator.

### EXAMPLE NUMBER 2

FIG. 6b depicts a polarization-dependent isolator design using a temperature and/or wavelength-dependent wave plate, 611 with a nominal center value of Φ₀=180 degrees (half wave plate). This design comprising a variable half wave plate, 611 requires an additional temperature and/or wavelength-independent quarter wave plate, 612 for functionality. Specifically this illustrative device includes consecutively the following elements:

Element 607 represents polarizing means with a nominal polarization axis of 0 degrees.

Element 608 represents Faraday rotator means with a nominal Faraday rotation of about Θ₀=45 degrees at the center specification of temperature and wavelength. Such Faraday rotator materials have well characterized dependences on wavelength (dispersion) and temperature such that the Faraday rotation at any given condition is Θ=Θ₀+θ, where θ is a function of wavelength and temperature.

Element 609 represents magnetization means to maintain the Faraday rotator in the magnetically-saturated, single-domain configuration required for device operation. More specifically, the magnetization means should be capable of applying a magnetic field greater than or equal to the saturating magnetic field of the Faraday rotator. For the case of coercive or magnetless Faraday rotator garnets, no such magnetization means is required.

Element 610 represents a retarder wave plate with a fast polarization axis of 90 degrees (relative to the input polarizer) and a nominal retardation δ₁=90 degrees at the temperature and wavelength conditions of operation. This is commonly called a quarter wave plate. In one preferred embodiment, this wave plate has a reduced dependence on temperature and/or wavelength in the range of operation. In a still more preferred embodiment, the retardation of this wave plate remains between about 89 and 91 degrees in the specification range.

Element 611 represents a temperature and/or wavelength-dependent retarder wave plate with a fast polarization axis of 45 degrees (relative to the input polarizer) and a nominal retardation of Φ₀=180 degrees at the center temperature and wavelength conditions of operation. This is commonly called a half wave plate. In one preferred embodiment, the variable retardation (Φ=Φ₀+φ) of this wave plate has a dependence on temperature (T) and/or wavelength (λ) approximately twice that of the temperature and/or wavelength dependence of the Faraday rotation (Θ) of element 608 in the range of operation. In a still more preferred embodiment 2×|dΘ/dT|=|dΦ/dT| and 2×|dΘ/dλ|=|dΦ/dλ|.

Element 612 represents a retarder wave plate with a fast polarization axis of 45 degrees (relative to the input polarizer) and a nominal retardation of δ₂=90 degrees at the temperature and wavelength conditions of operation. This is commonly called a quarter wave plate. In one preferred embodiment, this wave plate has a reduced dependence on temperature and/or wavelength in the range of operation. In a still more preferred embodiment, the retardation of this wave plate remains between about 89 and 91 degrees in the specification range. This wave plate is required to restore the circularly polarized light to linear or near-linear polarization. Because its axis is the same as element 611, it effectively turns element 611 into a three quarter wave plate, but its reduced temperature and/or wavelength dependence limits the overall temperature and/or wavelength dependence of this portion of the device as may be needed to match the Faraday rotator.

Element 613 represents polarizing means with a nominal polarization axis of 0 degrees (relative to the input polarizer).

The above design is complicated by inclusion of an additional element, 612, but has the advantage of being polarization-maintaining, i. e. returning the polarization to its initial value. Devices of this type may be extended to include a range of variable retardations, Φ₀ and fixed retardations δ₂ such that Φ₀+δ₂=270 degrees. This would allow a continuous variation of the temperature and/or wavelength dependence of the variable rotator over a factor of 3 since Φ₀ can vary from 90 to 270 and φ is proportional to Φ. This would additionally complicate device design by requiring a custom-made fixed wave plate 612.

A numerical Mueller matrix description of this device is illustrated in FIG. 7b. The top two lines of matrices show forward and reverse propagation for the center nominal values of the Faraday rotator 608, Θ₀=45 degrees, and the variable wave plate 611, Φ₀=180 degrees, which is nominally perfect propagation. The second two rows show forward and reverse propagation for a hypothetical maximum excursion (upper limit) of the variable wave plate 611 and Faraday rotator 608, φ=2θ=6 degrees, resulting from changes in temperature and/or wavelength. Results would be similar for the lower limit of variation, φ=2θ=−6 degrees. In this formulation, it is assumed that the first and last quarter wave plates have constant retardations. Because of the variation in the Faraday rotation, propagation can only be optimized in one direction. For optimum device operation, the device design and temperature/wavelength dependence of the variable wave plate 611 have been optimized for minimum (zero) reverse propagation, i. e. φ=2θ. For this condition, the extinction ratio and insertion loss performance of this device are expected to be similar to Example 1.

### EXAMPLE NUMBER 3

FIG. 6c depicts a polarization-dependent isolator design using a temperature and/or wavelength-dependent wave plate 618 with a nominal center value of 270 degrees (three quarter wave plate). Specifically this illustrative device includes consecutively the following elements:

Element 614 represents polarizing means with a nominal polarization axis of 0 degrees.

Element 615 represents Faraday rotator means with a nominal Faraday rotation of about Θ₀=45 degrees at the center specification of temperature and wavelength. Such Faraday rotator materials have well characterized dependences on wavelength (dispersion) and temperature such that the Faraday rotation at any given condition is Θ=Θ₀+θ, where θ is a function of wavelength and temperature.

Element 616 represents magnetization means to maintain the Faraday rotator in the magnetically-saturated, single-domain configuration required for device operation. More specifically, the magnetization means should be capable of applying a magnetic field greater than or equal to the saturating magnetic field of the Faraday rotator. For the case of coercive or magnetless Faraday rotator garnets, no such magnetization means is required.

Element 617 represents a retarder wave plate with a fast polarization axis of 90 degrees (relative to the input polarizer) and a nominal retardation δ=90 degrees at the temperature and wavelength conditions of operation. This is commonly called a quarter wave plate. In one preferred embodiment, this wave plate has a reduced dependence on temperature and/or wavelength in the range of operation. In a still more-preferred embodiment, the retardation of this wave plate remains between about 89 and 91 degrees in the specification range.

Element 618 represents a temperature and/or wavelength-dependent retarder wave plate with a fast polarization axis of 45 degrees (relative to the input polarizer) and a nominal retardation of Φ₀=270 degrees at the center temperature and wavelength conditions of operation. This is commonly called a three-quarter wave plate. In one preferred embodiment, the variable retardation (Φ=Φ₀+φ) of this wave plate has a dependence on temperature (T) and/or wavelength (λ) approximately twice that of the temperature and/or wavelength dependence of the Faraday rotation (Θ) of element 615 in the range of operation. In a still more preferred embodiment 2×|dΘ/dT|=|dΦ/dT| and 2×|dΘ/dλ|=|dΦ/dλ|. As in the case of Example 2 above, this wave plate may comprise a composite of temperature/wavelength-dependent and independent components with a net retardation of 270 degrees such that the wave plate is tuned to meet the condition(s) above.

Element 619 represents polarizing means with a nominal polarization axis of 0 degrees (relative to the input polarizer). In this configuration, the isolator is also polarization-maintaining.

A Mueller matrix description of Example 3 is shown in FIG. 7c. The top two lines of matrices show forward and reverse propagation for the center nominal values of the Faraday rotator 615, Θ₀=45 degrees, and the variable wave plate 618, Φ₀=270 degrees, which is nominally perfect propagation. The second two rows show forward and reverse propagation for a hypothetical maximum excursion (upper limit) of the variable wave plate 618 and Faraday rotator 615, φ=2θ=6 degrees, resulting from changes in temperature and/or wavelength. Results would be similar for the lower limit of variation, φ=2θ=−6 degrees. In this formulation, it is supposed that the first quarter wave plate has a constant retardation. Because of the variation in the Faraday rotation, propagation can only be optimized in one direction. For best device operation, the device design and temperature/wavelength dependence of the variable wave plate 618 have been optimized for minimum (zero) reverse propagation, i. e. φ=2θ. For this condition, the extinction ratio and insertion loss performance of this device are expected to be similar to Example 1.

It is evident that for these designs, reverse propagation is minimized for φ=2θ. If this is accomplished perfectly, the extinction ratio of the device will be constant over the range where the condition φ=2θ holds and the polarizers are effective. The temperature and/or wavelength dependence of the variable retarder must therefore be matched to that of the Faraday rotator. This can be accomplished by the following:

(1) Varying the amount of retardation, which is simply a function of thickness. The bi-directional nature of this device effectively limits the variable wave plate possibilities to approximately integral multiples of a quarter wave plate. Examples 1, 2 and 3 above show the first three in this series.

(2) Varying the specific wavelength dependence (1/Φ×dΦ/dλ) and/or the specific temperature dependence (1/Φ×dΦ/dT) of the variable rotator, which are intrinsic material properties. This is first accomplished by choice of material. For further understanding of the possibilities, retarder design must first be discussed.

Retarder wave plates can be made in the following configurations. In the examples below, a quarter wave retarder is described, but these designs apply to all retarders.

(1) True zero order wave plates of a single material and orientation of exactly ¼ wavelength (90 degrees) retardation. For inorganic crystalline materials with high specific retardations, these can be so thin as not to be practical for manufacture as a monolithic component.

(2) Multiple order wave plates with retardation equal to n+¼ wavelength=n×360+90 degrees, where n is an integer. These can have very high temperature and wavelength dependences.

(3) Compound wave plate designs made up of wave plates whose fast axes are oriented at 90 degrees to one another that differ in retardation by the desired net amount. For example, an N+¼ wave plate with a fast axis of 0 degrees may be laminated to an N wave plate with a fast axis of 90 degrees to create a compound zero order quarter wave plate with a fast axis of 0 degrees (N is not required to be an integer in this case). When the same material is used (for example, quartz) for the two wave plates, the compound wave plate has the same temperature and wavelength dependence as a true zero order wave plate. If the two materials are different, the differing dispersions and temperature dependences can be used to zero the dependence for the fixed retarder or tune the dependence of the variable retarder in a certain temperature and wavelength range. Using materials with a different sign of birefringence improves the wave plate's acceptance angle.

Both inorganic crystalline and polymer materials can be used for retarders in general, but many device designers require that there be no organic materials in, for example, hermetically sealed packages.

Most commonly the wavelength and temperature dependences of both the Faraday rotator and the variable retarder are all negative. However the present invention can be equally effective if the dependences of the two components are of opposite signs. It is only important that the dependences of the two components be of similar magnitude. If, for example, the retarder has a positive dependence of variable retardation, then a device similar to Example Number 1 can be made by changing the axis of the first retarder 604 to 0 degrees and the axis of the terminal polarizer 606 to be 0 degrees. This embodiment has the advantage of maintaining the polarization state through the device, but relatively few materials have positive dependences on wavelength or temperature.

To optimize device performance, the fixed quarter wave retarder(s) should be as nearly independent of temperature and wavelength as is possible in the region of interest. Compound material designs exist to accomplish this. The entire polarization rotator structure may be made as a single piece by the lamination of the two or three wave plates together, where each wave plate may itself be a composite laminate. Lamination may be accomplished by a variety of techniques including epoxy and epoxyless wafer bonding methods. Composite wave plates may also be assembled where the components are mechanically attached in a package, but are not in physical contact.

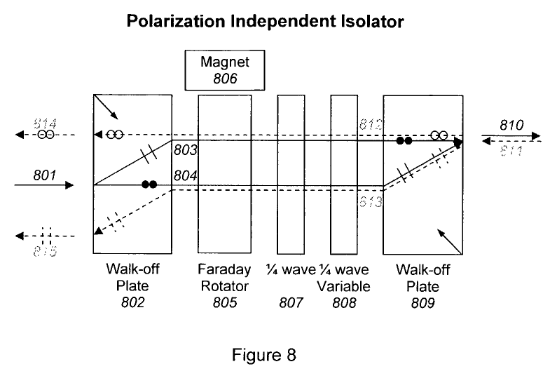

Mueller matrix formulations show that these device designs can be used with both 0 degree and 90 degree linear input polarizations. Therefore, with suitable birefringent means to separate these polarizations, the device designs above could be used for polarization independent devices with, for example, birefringent walkoff plates replacing the initial and terminal polarizing means. This would be effective for forward propagation of any linearly polarized beam. See FIG. 8.

The retardation of a wave plate is given by the equation

$$δ = \frac{2 π h Δ n}{λ} \qquad ( 2 )$$

where δ is the retardation, 2π (360 degrees) is a full wavelength of retardation, h is the wave plate thickness chosen to give the desired retardance for the material and wavelength, Δn is the birefringence, i. e. the difference between the ordinary and extraordinary refractive indices and λ is the wavelength of operation.

The temperature dependence of such a wave plate resides in the birefringence and the coefficient of linear expansion (P. D. Hale and G. W. Day, Appl. Optics 27, 5146 (1988)).

$$\frac{1}{δ} \frac{ⅆ δ}{ⅆ λ} = \frac{1}{Δ n} \frac{ⅆ Δ n}{ⅆ T} + {α}_{⊥} \qquad ( 3 )$$

α_{⊥} is the coefficient of thermal expansion perpendicular to the optic axis and is generally a small perturbation on the temperature dependence.

The wavelength dependence is more complex because of the strong 1/λ factor in the equation (P. D. Hale and G. W. Day, Appl. Optics 27, 5146 (1988)).

$$\frac{1}{δ} \frac{ⅆ δ}{ⅆ λ} = \frac{1}{Δ n} \frac{ⅆ Δ n}{ⅆ λ} - \frac{1}{λ} \qquad ( 4 )$$

It is therefore more difficult to produce an achromatic retarder than an athermal one, since a wave plate with a low wavelength dependence of birefringence still has a significant wavelength dependence of retardation from the second term.

Typically

$$\frac{1}{Δ n} \frac{ⅆ Δ n}{ⅆ λ} and \frac{1}{Δ n} \frac{ⅆ Δ n}{ⅆ T}$$

are negative, whether the birefringence is positive or negative. The table below gives some approximate data from the literature. Uncertainties for these values are not available, but the temperature derivatives are taken on very sparse data and are therefore of higher uncertainty. Wavelength dependences were taken at ˜1550 nm. Whenever possible, temperature dependences were taken at ˜1550 nm or extrapolated to 1550 nm—those cases where this could not be done are indicated as approximate.

| Material | Δn @˜1550 nm | $\begin{matrix}\frac{1}{Δn} \frac{ⅆ Δ n}{ⅆ λ} \\ ( {nm}^{- 1} )\end{matrix}$ | $\begin{matrix}\frac{1}{Δn} \frac{ⅆ Δ n}{ⅆ T} \\ ( {K}^{- 1} )\end{matrix}$ | $\begin{matrix}{α}_{⊥} \\ ( {K}^{- 1} )\end{matrix}$ | $\begin{matrix}\frac{1}{Δn} \frac{ⅆ Δ n}{ⅆ T} + {α}_{⊥} \\ ( {K}^{- 1} )\end{matrix}$ |
|---|---|---|---|---|---|
| SiO₂ Quartz | 0.0085^{ab} | −0.00007^{ab} | −0.00019 | −0.000014^{b} | −0.00018^{c} |
| LiNbO₃ | −0.079^{a} | −0.00007^{a} | −0.0006^{e} | 0.000015^{f} | −0.0006 |
| LiIO₃ | −0.14^{d} | −0.00007^{d} | −0.00009^{e} | 0.000028 | −0.00006 |
| NH₄H₂PO₄ | −0.0286^{a} | −0.00084^{a} | ˜−0.0015^{d} | 0.000027 | ˜−0.0015 |
| ADP | | | | | |
| KH₂PO₄ KDP | −0.0232^{a} | −0.00112^{a} | ˜−0.0012^{d} | 0.000025 | ˜−0.0012 |
| Al₂O₃ | −0.0079^{g} | −0.00001^{g} | ˜−0.0002 | 0.000005^{h} | ˜−0.0002 |
| Sapphire | | | | | |
| MgF₂ | 0.0114^{h} | −0.00003ⁱ | −0.00005^{h} | 0.000008^{h} | −0.00004^{c} |
| α-BaB₂O₄ | −0.075 | −0.0005 | −0.0001^{j} | 0.000004 | −0.0001 |
| BBO | | | | | |
| YVO₄ | 0.204 | −0.00003 | −0.00003 | 0.000004 | −0.00003 |
| TiO₂ Rutile | 0.25^{a} | −0.00004^{a} | −0.000001 | 0.000007 | +0.000006 |
| Calcite | −0.156^{ab} | −0.00009^{ab} | | 0.000024 | |
| −1/1310 nm | | −0.000763 | | | |
| −1/1550 nm | | −0.000645 | | | |

^{a}J. M. Bennett in Handbook of Optics, ed. by M. Bass et al., 2^{nd} ed. vol. II, p. 3.47 (1995) and references therein.
^{b}G. W. C. Kaye and T. H. Laby, Tables of Physical and Chemical Constants, 14^{th} ed. (1973).
^{c}P. D. Hale and G. W. Day, Appl. Optics 27, 5146 (1988).
^{d}V. G. Dmitriev et al. Handbook of Nonlinear Optical Crystals (1991) and ref. therein.
^{e}G. Ghosh, Opt. Lett. 19, 1391 (1994).
^{f}Y. S. Kim and R. T. Smith, J. Appl. Phys. 40, 4637 (1969).
^{g}I. H. Malitson, J. Opt. Soc. Am. 52, 1377 (1962).
^{h}A. Feldman et al. NBS Technical Note 993 (1979).
ⁱM. J. Dodge, Appl. Optics 23, 1980 (1984).
^{j}G. Ohosh, J. Appi. Phys. 78, 6752 (1995).
Un-attributed data are generally available, for example, from providers of crystal products or derived from the other data in the table.

To create a wave plate that can compensate for the wavelength dependence of Faraday rotator materials at the wavelengths of interest, the following condition must be met or approximated.

$$\frac{ⅆ δ}{ⅆ λ} = δ ( \frac{1}{Δ n} \frac{ⅆ Δ n}{ⅆ λ} - \frac{1}{λ} ) = 2 \frac{ⅆ Θ}{ⅆ λ} \qquad ( 5 )$$

This can be solved for a wavelength matched retardation δ_{λ}.

$${δ}_{λ} = \frac{2 \frac{ⅆ Θ}{ⅆ λ}}{( \frac{1}{Δ n} \frac{ⅆ Δ n}{ⅆ λ} - \frac{1}{λ} )} \qquad ( 6 )$$

To create a wave plate that can compensate for the temperature dependence of standard or magnetless Faraday rotator material, the following condition must be met or approximated.

$$\frac{ⅆ δ}{ⅆ T} = δ ( \frac{1}{Δ n} \frac{ⅆ Δ n}{ⅆ T} + {α}_{⊥} ) = 2 \frac{ⅆ Θ}{ⅆ T} \qquad ( 7 )$$

This can be solved for a temperature matched retardance δ_{T}.

$${δ}_{T} = \frac{2 \frac{ⅆ Θ}{ⅆ T}}{( \frac{1}{Δ n} \frac{ⅆ Δ n}{ⅆ T} + {α}_{⊥} )} \qquad ( 8 )$$

The table below gives these calculated matching retardances in degrees. Approximate thicknesses in microns are also given.

| | δ_{λ}(1310)/h | δ_{λ}(1550)/h | δ_{T}(Standard)/h | δ_{T}(Magnetless)/h |
|---|---|---|---|---|
| | (degrees)/ | (degrees)/ | (degrees)/ | (degrees)/ |
| Material | (μm) | (μm) | (μm) | (μm) |
| SiO₂ Quartz | 192/81 | 151/77 | 667/312 | 1033/483 |
| LiNbO₃ | 192/9 | 151/8 | 200/10 | 310/16 |
| LilO₃ | 192/5 | 151/5 | 2000/57 | 3100/88 |
| NH₄H₂PO₄ | 100/11 | 73/11 | 80/11 | 124/17 |
| ADP | | | | |
| KH₂PO₄ | 85/11 | 61/11 | 100/17 | 155/27 |
| KDP | | | | |
| Al₂O₃ | 207/95 | 165/90 | 600/302 | 930/468 |
| Sapphire | | | | |
| MgF₂ | 201/64 | 159/60 | 3000/1045 | 4650/1620 |
| α-BaB₂O₄ | 127/5 | 94/5 | 1200/64 | 1860/99 |
| BBO | | | | |
| YVO₄ | 202/4 | 160/3 | 4000/78 | 6200/121 |
| TiO₂ Rutile | 199/3 | 158/3 | 20000/318 | 31000/493 |
| Calcite | 188/4 | 147/4 | | |

Since the variable wave plate must be a zero order wave plate of an integral multiple of 90 degrees, wavelength compensation could be accomplished with a quarter wave plate for the materials with large

$$\frac{1}{Δ n} \frac{ⅆ Δ n}{ⅆ λ}$$

(ADP, KDP, BBO) or a half wave plate for all others. The thicker materials are more practically fabricated. The thinner materials can only be fabricated as a free standing component as compound zero order wave plates and even then require much greater precision. For wavelength compensation only, compound zero order half wave plates of quartz are readily available, well understood and have been optimized for manufacture. However, such a wave plate would only compensate for 17-27% of the temperature dependence of the Faraday rotator.

The values of

$$\frac{1}{Δ n} \frac{ⅆ Δ n}{ⅆ T}$$

vary much more widely. For the materials with high temperature dependence (lithium niobate, ADP, KDP), compensation can be achieved with a quarter to half wave plate similar to that required for wavelength compensation. For more moderate temperature dependences, thicker wave plates would be required, e. g. 1¾ to 2¾ wave plates of quartz, which would overcompensate substantially for wavelength dependence. However such wave plates could readily be obtained commercially.

If it is desired to make a wave plate with both a temperature dependence and wavelength dependence matching those of the Faraday rotator, then equations (5) and (7) above must hold simultaneously. Setting δ equal in both these equations yields

$$\frac{( \frac{1}{Δ n} \frac{ⅆ Δ n}{ⅆ T} + {α}_{⊥} )}{\frac{ⅆ Θ}{ⅆ T}} = \frac{( \frac{1}{Δ n} \frac{ⅆ Δ n}{ⅆ λ} - \frac{1}{λ} )}{\frac{ⅆ Θ}{ⅆ λ}} \qquad ( 9 )$$

The residual quantity

$$R = \frac{( \frac{1}{Δ n} \frac{ⅆ Δ n}{ⅆ T} + {α}_{⊥} )}{\frac{ⅆ Θ}{ⅆ T}} - \frac{( \frac{1}{Δ n} \frac{ⅆ Δ n}{ⅆ λ} - \frac{1}{λ} )}{\frac{ⅆ Θ}{ⅆ λ}} \qquad ( 10 )$$

is a good measure of the material match.

The temperature dependence of the birefringence must exceed the wavelength dependence by a significant amount to balance these equations. In the table above, two single materials meet this criterion, LiNbO₃ and ADP. Below are given some examples of how these materials might be used to compensate Standard and Magnetless Faraday rotators at the telecommunications wavelengths of 1550 and 1310 nm.

| Retarder | Faraday Rotator/ Wavelength | R | δ @center λ | $\begin{matrix}2 \frac{ⅆ Θ}{ⅆ λ} \\ ( ° / nm )\end{matrix}$ | $\begin{matrix}\frac{ⅆ δ}{ⅆ λ} \\ ( ° / nm )\end{matrix}$ | $\begin{matrix}2 \frac{ⅆ Θ}{ⅆ T} \\ ( ° / K )\end{matrix}$ | $\begin{matrix}\frac{ⅆ δ}{ⅆ T} \\ ( ° / K )\end{matrix}$ |
|---|---|---|---|---|---|---|---|
| LiNbO₃ | Standard/ | 0.0017 | 180° | −0.108 | −0.13 | −0.12 | −0.11 |
| | 1550 nm | | | | | | |
| LiNbO₃ | Magnetless/ | 0.0035 | 180° | −0.108 | −0.13 | −0.186 | −0.11 |
| | 1550 nm | | | | | | |
| LiNbO₃ | Standard/ | 0.0003 | 180° | −0.16 | −0.15 | −0.12 | −0.11 |
| | 1310 nm | | | | | | |
| LiNbO₃ | Magnetless/ | 0.0021 | 270° | −0.16 | −0.22 | −0.186 | −0.16 |
| | 1310 nm | | | | | | |
| ADP | Standard/ | 0.0015 | 90° | −0.108 | −0.13 | −0.12 | −0.13 |
| | 1550 nm | | | | | | |
| ADP | Magnetless/ | 0.0058 | 90° | −0.108 | −0.13 | −0.186 | −0.13 |
| | 1550 nm | | | | | | |
| ADP | Standard/ | −0.0023 | 90° | −0.16 | −0.14 | −0.12 | −0.13 |
| | 1310 nm | | | | | | |
| ADP | Magnetless/ | 0.0021 | 90° | −0.16 | −0.14 | −0.186 | −0.13 |
| | 1310 nm | | | | | | |

The data in the table above should be reviewed with the knowledge that the temperature dependence data for birefringence is of relatively poor accuracy. However they show generally, that retarder materials with significantly higher temperature dependence than wavelength dependence can be used to compensate both dependences in the Faraday rotator. The data above suggest that a true or compound zero order lithium niobate half wave plate or a true or compound zero order ADP quarter wave plate can be used effectively to compensate both the wavelength and temperature dependences of a nominal standard Faraday rotator material (one that requires a magnetic field to remain saturated). The high temperature dependence of a magnetless Faraday rotator is more difficult to compensate. A lithium niobate ¾ wave plate can be used to compensate most the temperature dependence, but would have too high of a wavelength dependence.

A composite wave plate might be tuned to compensate more perfectly for both the wavelength and temperature dependences of the Faraday rotator by using materials with similar wavelength dependences dependence and differing temperature dependences. The composite of quartz and magnesium fluoride is well known for the creation of achromatic Faraday rotators and so could be readily adapted for use in the present invention. For example, a composite of an N=2.3 quartz wave plate oriented with its fast axis at 90 degrees to an N=2.05 MgF₂ wave plate (overall thickness approximately 700 μm) would have a calculated overall wavelength dependence

$$\frac{ⅆ δ}{ⅆ λ} of - 0.092$$

degrees/nm at 1550 nm and calculated temperature dependence

$$\frac{ⅆ δ}{ⅆ T} of - 0.120$$

degrees/K compared to

$$2 \frac{ⅆ Θ}{ⅆ λ} = - 0.108$$

degrees/nm and

$$2 \frac{ⅆ Θ}{ⅆ T} = - 0.120$$

degrees/K for a standard Faraday rotator material at 1550 nm. For a magnetless material, the match is better. A composite of an N=3.6 quartz wave plate oriented with its fast axis at 90 degrees to an N=3.35 MgF₂ wave plate (overall thickness approximately 1100 μm) would have a calculated overall wavelength dependence

$$\frac{ⅆ δ}{ⅆ λ} of - 0.109$$

degrees/nm at 1550 nm and calculated temperature dependence

$$\frac{ⅆ δ}{ⅆ T} of - 0.185$$

degrees/K compared to

$$2 \frac{ⅆ Θ}{ⅆ λ} = - 0.108$$

degrees/nm and

$$2 \frac{ⅆ Θ}{ⅆ T} = - 0.186$$

degrees/K for a magnetless Faraday rotator at 1550 nm. The data for quartz and MgF₂ are well determined (P. D. Hale and G. W. Day, Appl. Optics 27, 5146 (1988)) so these values should be close to accurate.

The construction of achromatic retarders that use the difference between the wavelength dependences of two materials to compensate for the 1/λ contribution is well understood (see, for example, J. M. Bennett in Handbook of Optics, ed. by M. Bass et al., 2^{nd} ed. vol. II, pp. 3.52-3.56 (1995)). Quartz and MgF₂ are a commonly used pair for this application. The data above suggests that an achromatic quarter wave plate could be made with an MgF₂ N=4.85 retarder and a quartz N=4.6 retarder, but such a composite would have a high estimated temperature dependence

$$\frac{ⅆ δ}{ⅆ T} of - 0.23$$

degrees/K. Hale and Day (Appl. Optics 27, 5146 (1988)) suggested that an athermal retarder could be made using the same principles as are used to make an achromatic retarder. However, to produce a fixed retarder, as is desired for this invention, with low dependences on both wavelength and temperature, a smaller selection of materials is available. The match is optimized if there be a differential in the wavelength dependence of the two materials, but that they have similar temperature dependences.

A component comprising a Faraday rotator and a polarization rotator as described above can also be used in other non-reciprocal devices such as circulators, switches and interleavers by means known to those skilled in the art of device design to reduce the temperature and/or wavelength dependence of the device.

What is claimed:

1. A temperature-dependent polarization rotator comprising:
(a) temperature dependent retarder means, and
(b) quarter wave plate means arrayed with respect to the temperature-dependent retarder means such that light passes through each said means consecutively and such that the angle between the two fast axes of the respective said means lies in the range (m×45 degrees) ± about 5 degrees, where m is an odd integer.

2. A temperature-dependent polarization rotator comprising
(a) temperature dependent retarder means, and
(b) quarter wave plate means arrayed with respect to the temperature-dependent retarder means such that light passes through each said means consecutively and such that the angle between the two fast axes of the respective said means lies in the range (m×45 degrees ± about 2 degrees, where m is an odd integer.

3. A wavelength-dependant polarization rotator comprising:
(a) wavelength-dependent retarder means, and
(b) quarter wave plate means arrayed with respect to the wavelength-dependent retarder means such that light passes through each said means consecutively and such that the angle between the two fast axes of the respective said means lies in the range (m×45 degrees) ± about 5 degrees, where m is an odd integer.

4. A wavelength-dependent polarization rotator comprising:
(a) wavelength-dependent retarder means, and
(b) quarter wave plate means arrayed with respect to the wavelength-dependent retarder means such that light passes through each said means consecutively and such that the angle between the two fast axes of the respective said means lies in the range (m×45 degrees ± about 2 degrees, where m is an odd integer.

5. A wavelength and temperature-dependent polarization rotator comprising:
(a) wavelength and temperature dependent retarder means, and
(b) quarter wave plate means arrayed with respect to the wavelength and temperature-dependent retarder means such that light passes through each said means consecutively and such that the angle between the two fast axes of the respective said means lies in the range (m×45 degrees) ± about 5 degrees, where m is an odd integer.

6. A wavelength and temperature-dependent polarization rotator comprising:
(a) wavelength and temperature dependent retarder means, and
(b) quarter wave plate means arrayed with respect to the wavelength and temperature-dependent retarder means such that light passes through each said means consecutively and such that the angle between the two fast axes of the respective said means lies in the range (m×45 degrees ± about 2 degrees, where m is an odd integer.

7. A wavelength and temperature-dependent polarization rotator comprising:
(a) wavelength and temperature dependent retarder means in which the retarder is a material selected from the group consisting of lithium niobate, ammonium dihydrogen phosphate, a composite material, a composite of alpha-quartz and magnesium fluoride or a composite of polymer materials, and
(b) quarter wave plate means arrayed with respect to the wavelength and temperature-dependent retarder means such that light passes through each said means consecutively and such that the angle between the two fast axes of the respective said means lies in the range (m×45 degrees) ± about 5 degrees, where m is an odd integer.

8. A wavelength and temperature-dependent polarization rotator comprising:
(a) wavelength and temperature dependent retarder means in which the retarder is a material selected from the group consisting of lithium niobate, ammonium dihydrogen phosphate, a composite material, a composite of alpha-quartz and magnesium fluoride or a composite of polymer materials, and
(b) quarter wave plate means arrayed with respect to the wavelength and temperature-dependent retarder means such that light passes through each said means consecutively and such that the angle between the two fast axes of the respective said means lies in the range (m×45 degrees ± about 2 degrees, where m is an odd integer.

9. An optical device employing a polarization rotator in accordance with any one of claims 1, 2, 5, 6, 7 and 8 wherein the absolute value of the temperature dependence of variable rotation |dΦ/dT| is equal to X times the absolute value of the temperature dependence of the System Polarization |dSP/dT| where X is between about 1 and 3.

10. An optical device employing a polarization rotator in accordance with any one of claims 1, 2, 5, 6, 7 and 8 wherein the absolute value of the temperature dependence of variable rotation |dΦ/dT| is equal to X times the absolute value of the temperature dependence of the System Polarization |dSP/dT| where X is between about 1.5 and 2.5.

11. An optical device employing a polarization rotator in accordance with any one of claims 3, 4, 5, 6, 7 and 8 wherein the absolute value of the wavelength dependence of variable rotation |dΦ/dλ| is equal to Y times the absolute value of the wavelength dependence of the System Polarization |dSP/dλ| where Y is between about 1 and 3.

12. An optical device employing a polarization rotator in accordance with any one of claims 3, 4, 5, 6, 7 and 8 wherein the absolute value of the wavelength dependence of variable rotation |dΦ/dλ| is equal to Y times the absolute value of the wavelength dependence of the System Polarization |dSP/dλ| where Y is between about 1.5 and 2.5.

13. An optical device employing a polarization rotator in accordance with any one of claims 1, 2, 5, 6, 7 and 8 wherein the absolute value of the temperature dependence of variable rotation |dΦ/dT| is equal to X times the absolute value of the temperature dependence of the Faraday rotation |dΘ/dT| where X is between about 1 and 3.

14. An optical device employing a polarization rotator in accordance with any one of claims 1, 2, 5, 6, 7 and 8 wherein the absolute value of the temperature dependence of variable rotation |dΦ/dT| is equal to X times the absolute value of the temperature dependence of the Faraday rotation |dΘ/dT| where X is between about 1.5 and 2.5.

15. An optical device employing a polarization rotator in accordance with any one of claims 3, 4, 5, 6, 7 and 8 wherein the absolute value of the wavelength dependence of variable rotation |dΦ/dλ| is equal to Y times the absolute value of the wavelength dependence of the Faraday rotation |dΘ/dλ| where Y is between about 1 and 3.

16. An optical device employing a polarization rotator in accordance with any one of claims 3, 4, 5, 6, 7 and 8 wherein the absolute value of the wavelength dependence of variable rotation |dΦ/dλ| is equal to Y times the absolute value of the wavelength dependence of the Faraday rotation |dΘ/dλ| where Y is between about 1.5 and 2.5.

17. An optical device employing a polarization rotator in accordance with any one of claims 1, 2, 5, 6, 7 and 8 wherein
(a) the variable retarder has a retardation of (n×90 degrees) ± about 5 degrees (where n is an odd integer) at the center of a specified wavelength and temperature range and
(b) the absolute value of the temperature dependence of variable rotation |dΦ/dT| is equal to X times the absolute value of the temperature dependence of the System Polarization |dSP/dT| where X is between about 1 and 3.

18. An optical device employing a polarization rotator in accordance with any one of claims 1, 2, 5, 6, 7 and 8 wherein
(a) the variable retarder has a retardation of (n×90 degrees) ± about 5 degrees (where n is an odd integer) at the center of a specified wavelength and temperature range and
(b) the absolute value of the temperature dependence of variable rotation |dΦ/dT| is equal to X times the absolute value of the temperature dependence of the System Polarization |dSP/dT| where X is between about 1.5 and 2.5.

19. An optical device employing a polarization rotator in accordance with any one of claims 3, 4, 5, 6, 7 and 8 wherein
(a) the variable retarder has a retardation of (n×90 degrees) ± about 5 degrees (where n is an odd integer) at the center of a specified wavelength and temperature range and
(b) the absolute value of the wavelength dependence of variable rotation |dΦ/dλ| is equal to Y times the absolute value of the wavelength dependence of the System Polarization |dSP/dλ| where Y is between about 1 and 3.

20. An optical device employing a polarization rotator in accordance with any one of claims 3, 4, 5, 6, 7 and 8 wherein
(a) the variable retarder has a retardation of (n×90 degrees) ± about 5 degrees (where n is an odd integer) at the center of a specified wavelength and temperature range and
(b) the absolute value of the wavelength dependence of variable rotation |dΦ/dλ| is equal to Y times the absolute value of the wavelength dependence of the System Polarization |dSP/dλ| where Y is between about 1.5 and 2.5.

21. An optical device employing a polarization rotator in accordance with any one of claims 1, 2, 5, 6, 7 and 8 wherein
(a) the variable retarder has a retardation of (n×90 degrees) ± about 5 degrees (where n is an odd integer) at the center of a specified wavelength and temperature range and
(b) the absolute value of the temperature dependence of variable rotation |dΦ/dT| is equal to X times the absolute value of the temperature dependence of the Faraday rotation |dΘ/dT| where X is between about 1 and 3.

22. An optical device employing a polarization rotator in accordance with any one of claims 1, 2, 5, 6, 7 and 8 wherein
(a) the variable retarder has a retardation of (n×90 degrees) ± about 5 degrees (where n is an odd integer) at the center of a specified wavelength and temperature range and
(b) the absolute value of the temperature dependence of variable rotation |dΦ/dT| is equal to X times the absolute value of the temperature dependence of the Faraday rotation |dΘ/dT| where X is between about 1.5 and 2.5.

23. An optical device employing a polarization rotator in accordance with any one of claims 3, 4, 5, 6, 7 and 8 wherein
(a) the variable retarder has a retardation of (n×90 degrees) ± about 5 degrees (where n is an odd integer) at the center of a specified wavelength and temperature range and
(b) the absolute value of the wavelength dependence of variable rotation |dΦ/dλ| is equal to Y times the absolute value of the wavelength dependence of the Faraday rotation |dΘ/dλ| where Y is between about 1 and 3.

24. An optical device employing a polarization rotator in accordance with any one of claims 3, 4, 5, 6, 7 and 8 wherein
(a) the variable retarder has a retardation of (n×90 degrees) ± about 5 degrees (where n is an odd integer) at the center of a specified wavelength and temperature range and
(b) the absolute value of the wavelength dependence of variable rotation |dΦ/dλ| is equal to Y times the absolute value of the wavelength dependence of the Faraday rotation |dΘ/dλ| where Y is between about 1.5 and 2.5.

25. A device employing a polarization rotator accordance with any one of claims 1 through 24 inclusive in which the said device is a magnetooptic isolator.

26. A device employing a polarization rotator in accordance with any one of claims 1 through 24 inclusive in which the said device is an optical circulator.

27. A device employing a polarization rotator in accordance with any one of claims 1 through 24 inclusive in which the said device is a magnetooptic switch.

28. A device employing a polarization rotator in accordance with any one of claims 1 through 24 inclusive in which the said device is an interleaver.
